(19) United States
(12) Patent Application Publication
(10) Pub. No.: US 2025/0178524 A1
(43) Pub. Date: Jun. 5, 2025

(54) CODED TEXTURAL ELEMENT

(71) Applicant: Ford Global Technologies, LLC, Dearborn, MI (US)

(72) Inventors: Stuart C. Salter, White Lake, MI (US); Melissa Coolsaet, Ferndale, MI (US); Jeff Robert Seaman, Petersburg, MI (US); Tim Michael Farmer, Clinton Township, MI (US); Ahmad Miqdadi, Ann Arbor, MI (US); Brendan Diamond, Grosse Pointe, MI (US)

(73) Assignee: Ford Global Technologies, LLC, Dearborn, MI (US)

(21) Appl. No.: 18/527,778

(22) Filed: Dec. 4, 2023

(51) Int. Cl. B60Q 3/14; B60Q 1/00; B60R 13/00

(52) U.S. Cl. CPC B60Q 3/14; B60Q 1/0035; B60R 13/005

(57) ABSTRACT

A textural element having a component having a front surface and coding, such as binary coding, provided on the front surface of the component, the coding including a plurality of code characters, each code character comprising a plurality of digits. The component may be for a motor vehicle.

### FIELD OF THE DISCLOSURE

The present disclosure generally relates to viewable elements that display a message, and more particularly relates to a textural message element presenting a coded message on a component, such as on a vehicle.

### BACKGROUND OF THE DISCLOSURE

Articles of manufacture such as motor vehicles and components therefor typically include alphanumeric messaging such as brand names and other messages. It may be desirable to provide other forms of messaging.

### SUMMARY OF THE DISCLOSURE

According to a first aspect of the present disclosure, a textural element includes a component having a front surface and coding provided on the front surface of the component, the coding including a plurality of code characters, each code character comprising a plurality of digits.

Embodiments of the first aspect of the present disclosure can include any one or a combination of the following features:
the plurality of code characters translates to a message;
the message includes at least one of a trade name and logo;
the plurality of digits are binary digits provided as a series of binary bits, each representing digital 1 (one) or digital 0 (zero);
the digital 1s (ones) and digital 0s (zeros) are represented by dark and light markings;
the dark and light markings are represented as rectangular boxes;
the digital 1s (ones) and digital 0s (zeros) are represented by opaque and transparent markings;
a light illumination source that is operatively coupled to the coding for illuminating light through the transparent markings;
the component is on a door on a vehicle, wherein the illuminated pattern is illuminated to the exterior of the vehicle; and
the component is provided on a dashboard or trim panel of a vehicle.

According to a second aspect of the present disclosure, the textual element includes a substrate having a front surface and binary coding provided on the front surface of the substrate, the binary coding including a plurality of binary code characters, each binary code character comprising a plurality of binary digits.

Embodiments of the second aspect of the present disclosure can include any one or a combination of the following features:
the plurality of binary code characters translates to a message;
the message includes at least one of a trade name and logo;
the plurality of binary digits are provided as a series of binary bits, each representing digital 1 (one) or digital 0 (zero);
the digital 1s (ones) and digital 0s (zeros) are represented by dark and light markings;
the dark and light markings are represented as rectangular boxes;
the digital 1s (ones) and digital 0s (zeros) are represented by opaque and transparent markings;
a light illumination source operatively coupled to the binary coding for illuminating light through the transparent markings; and
the substrate is one of a door of a vehicle, on a dashboard or trim panel of the vehicle.

According to a third aspect of the present disclosure, the textural element for a vehicle includes a component having a front surface, and binary coding provided on the front surface of the component, the binary coding including a plurality of binary code characters, each binary code character comprising a plurality of binary digits.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side view of a motor vehicle having a textural element providing a coded message on the exterior side of a door with back lit illumination, according to one embodiment;

FIG. 2 is a rear perspective view of the forward portion of the cabin interior of the motor vehicle further illustrating textural elements in the cabin interior, according to one embodiment;

FIG. 3 is an example of a textural element on an audio speaker having binary coding for displaying a coded message in a repeated fashion, according to one embodiment;

FIG. 4 is an enlarged front view of a portion of the binary coding on the textural element for providing the coded message, according to one example;

FIG. 5 is a front view of hexadecimal coding for displaying a coded message on a textural element, according to another embodiment;

FIG. 6 is a translation table showing the hexadecimal codes and conversion to binary coding;

FIG. 7 is a schematic side view of a printing process for printing the binary coding on a component or substrate of the textural element, according to one example;

FIG. 8 is a schematic side view of a textural element located on a windshield of the vehicle, according to one example;

FIG. 9 is a side view of a textural element having an illuminated binary coding, according to one example;

FIG. 10 is a schematic cross-sectional view of the layers of a textural element on a dashboard with backlighting; and

FIG. 11 is a schematic cross-sectional view of a capacitive switch with a binary code provided on the viewable surface.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

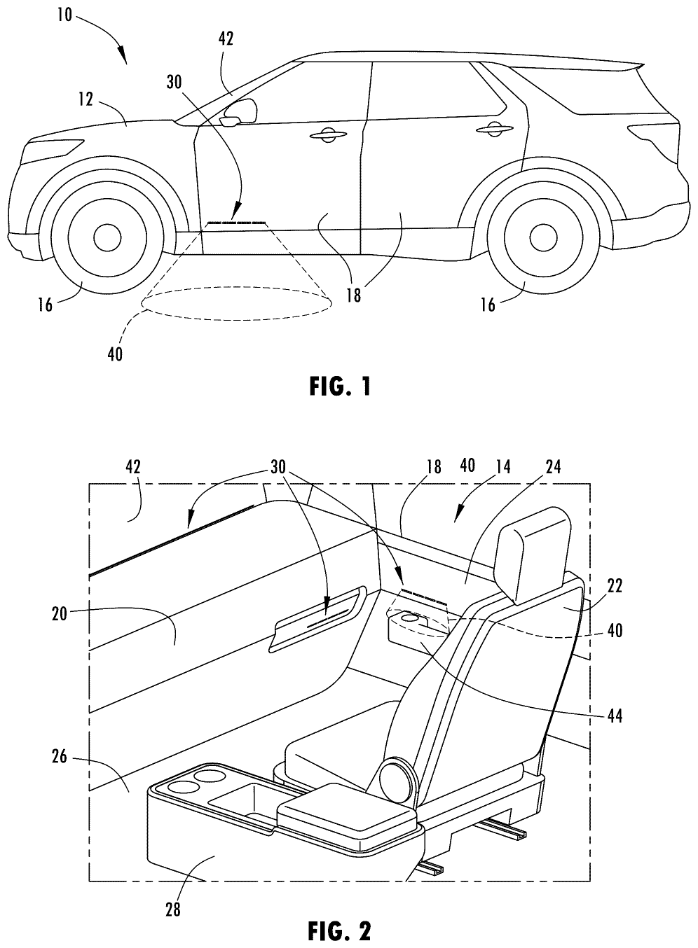

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a textural element having coding providing a coded message and to a vehicle having the textural element. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1 and 2, a wheeled automotive or motor vehicle 10 is generally illustrated having a vehicle body 12 defining a cabin interior 14. The cabin interior 14 generally includes passenger seating 22 and other accommodations for transporting one or more occupants. The motor vehicle 10 shown and described herein is a wheeled motor vehicle having a plurality of wheel and tire assemblies 16 mounted onto the axles of the motor vehicle 10. The motor vehicle 10 has a plurality of side doors 18 on both lateral sides of the body 12 for accessing the cabin interior 14.

The cabin interior 14 is shown in FIG. 2 having a passenger seat 22 located next to a center console 28 at the front of the cabin interior 14. It should be appreciated that additional seating such as a driver's seat may be located in the front row on the opposite side of the center console 28 from the passenger seat 22 and that further seating may be provided in one or more rearward rows of seating. The cabin interior 14 includes interior trim including a door trim panel 24 on the inside surface of the door 18. The door trim panel 24 may include a cup holder 44 and other compartments such as a door handle and map compartment, for example. Forward of the seating at the forward end of the cabin interior 14 is a dashboard 20 which is generally shown located forward of the passenger seat 22. A windshield 42 extends across a portion of the body 12 at the front end of the cabin interior 14. The windshield 42 may include a frit region generally along a periphery which may be used to present a message.

The motor vehicle 10 is equipped with one or more textural elements 30 which include an underlying component or substrate and coding forming a coded message provided on the front surface of the component or substrate to display the coded message. As seen in FIG. 1, one example of a textural element 30 is shown located on the exterior side of the front lateral door 18. The textural element 30 includes a component which in this example is a door panel which is typically coated with paint. The component may include a molding typically made of a polymeric material or tape such as pin stamping tape, for example. The textural element 30 includes a coded pattern or message that can be viewable from outside of the motor vehicle 10. In addition, the textural element 30 with the coded message shown on the outer surface of the door 18 may be illuminated with backlighting on the back side to illuminate a lighted pattern 40 on the exterior of the motor vehicle 10, which may be directed onto the ground to form a puddle lamp displaying the lighted pattern 40 on the ground proximate to the motor vehicle 10, for example.

Referring to FIG. 2, a textural element 30 is shown located in cabin interior 14 in the dashboard 20, generally forward of the passenger seat 22. In this example, the dashboard 20 may be made of a vinyl or polymeric material which may serve as the component or substrate and may include the textural element 30 having a coded pattern or message integrally formed therein or impressed or printed thereon. The textural element 30 may display a coded message indicative of a trade name or a logo, for example.

In addition, a textural element 30 is also shown in the cabin interior 14 located on the A-surface of the door trim 24 on the interior side of door 18. In this example, the A-surface of the door trim 24 may serve as the component or substrate. The coded message may be printed or impressed on the component. The textural element 30 provided in the door trim 24 may be illuminated with lighting on the backside to focus the illuminating light through the coding and into the cup holder 44 there below, for example.

A further textural element 30 with a coded message is shown located in the glass frit area of the windshield 42. The coded message may be printed on the interior or exterior side of the windshield 42 as part of or proximate to the frit area generally near a periphery of the windshield 42.

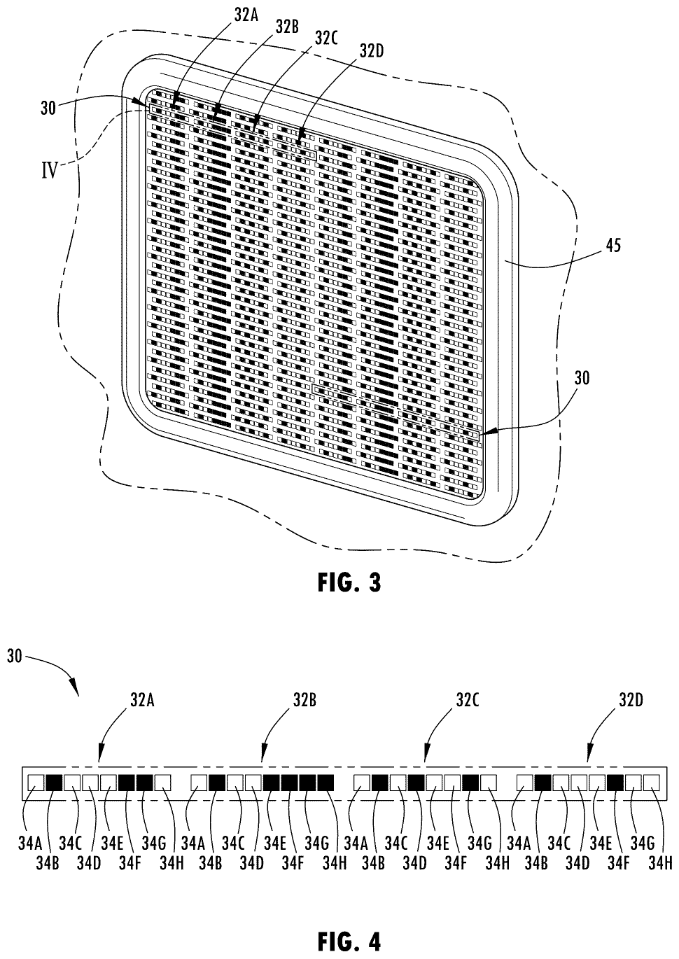

According to one embodiment, the coding may include binary coding. The textural element 30 is provided with a component or substrate having the binary coding on the outer viewing surface to provide a series of binary codes as shown in the examples in FIGS. 3 and 4, which, when translated, represent alphanumeric characters. The binary codes 32A-32D are configured to provide a binary coded message, which may translate to an alphanumeric message to include a name, trademark, trade name, logo, instructions, announcements, or other message that can be identifiable through the translation from binary code to an alphanumeric message. In the example shown in FIG. 4, the binary codes 32A-32D provide a coded message that translates to an alphanumeric message that reads “Ford”.

Each binary code, such as binary code 32A, includes a series of binary digits or bits 34A-34H. Each binary code is provided in eight bits, also referred to as a byte, each bit providing a digital 1 (one) or digital 0 (zero). According to one example, the digital 0s (zeros) may be represented by transparent or open space boxes that are not shaded, whereas the digital 1s (ones) may be represented by opaque or dark shaded rectangular boxes such as is shown in bits 34B, 34F, and 34G of binary code 34A or may be circular shaped. According to another example, the bits representing digital 0s (zeros) may be light blocking opaque, and the bits representing digital 1s (ones) may be light transparent such that the digital 1s (ones) may be illuminated with light to give a lighted binary code pattern. According to a further example, the digital 1s (ones) may be represented by a first color, and the digital 0s (zeros) may be represented by a different second color. The representation of digital 0s (zeros) and 1s (ones) may be switched according to other examples. The light illumination may be generated with light emitting diodes (LEDs) such as red-green-blue LEDs that generate the first and second color light.

Referring to FIG. 3, a component in the form of an audio speaker cover 45 is shown with a repeated binary code pattern 30 printed thereon to provide a textural element 30, according to one example. The speaker cover 45 is a component that may be made of sound transmissive material overlaying an audio speaker. In this example, the binary code 32A-32D are repeated over and over on the same row or line and on subsequent rows or lines so as to provide the same repeated binary coded message. It should be appreciated that other binary coded messages may be provided alone or in combination with different binary coded messages on various components or substrates to provide textural elements, according to other examples.

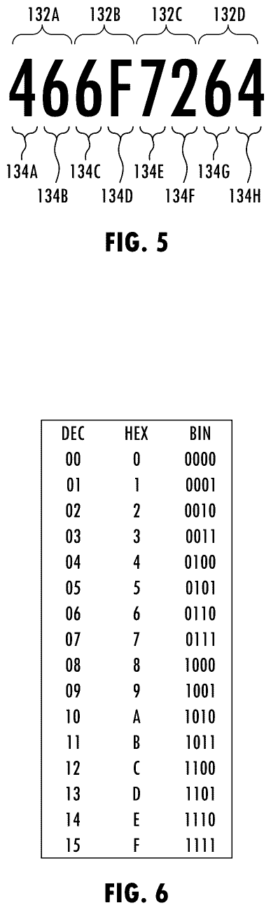

According to another embodiment, the coding may include a hexadecimal code which is illustrated in FIGS. 5 and 6. As seen in FIG. 5, the chart illustrates hexadecimal digits relative to the translation to the binary code. In total, there are 16 hexadecimal digits that may be employed to represent a coded message. Each digit may translate to four bits of the binary code. As such, the hexadecimal coding may be used to provide a translated message into binary code which further may be translated into an alphanumeric message. The hexadecimal digits include numbers 0 (zero) through 9 (nine) and letters A through F, which correspond to the 16 available digits.

One example of a hexadecimal coded message is illustrated in FIG. 6. The hexadecimal message provided in FIG. 6 translates to the alphanumeric wording “FORD.” Included is the first hexadecimal code 132A, the second hexadecimal code 132B, the third hexadecimal code 132C, and the fourth hexadecimal code 132D. The first hexadecimal code 132A includes a first digit 134A and a second digit 134B. The second hexadecimal code 132B includes a third digit 134C and a fourth digit 134D. The third hexadecimal code 132C includes a fifth digit 134E and a sixth digit 134F. The fourth hexadecimal code 132D includes a seventh digit 134G and an eighth digit 134H. It should be appreciated that more or less hexadecimal codes may be included to provide a hexadecimal coded message that may be translated to binary code and further translated to an alphanumeric message. As such, the hexadecimal code requires fewer digits than the binary code, which may be particularly advantageous when using illuminated digits.

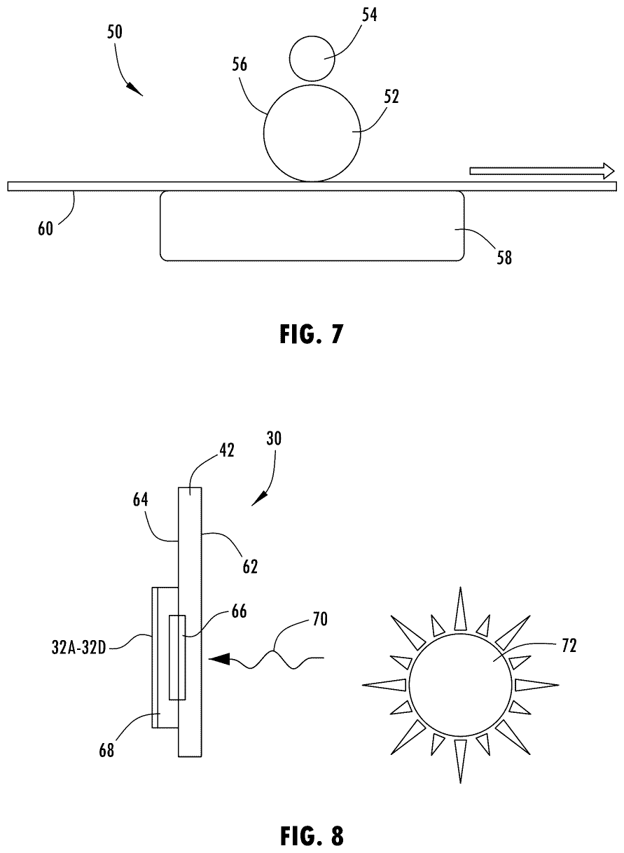

Referring to FIG. 7, one example of a method of making the textural element 30 is shown using a printing assembly 50 for performing a printing process. The printing process may be implemented on the printer assembly 50 that includes a heated roller 52, operatively coupled to a foam roller 54. The heated roller 52 may include a printed pattern 56 that provides the coded pattern or message. The foam roller 54 may be in fluid communication with a supply of liquid paint or ink and in contact with the heated roller 52 to apply the liquid paint to the heated roller. As such, as the heated roller 52 rotates about a component or substrate 60 that passes thereunder between the base 58 and the heated roller 52, and the front surface of the substrate 60 is printed with the patterned code and allowed to dry or cure. It should be appreciated that the patterned code may otherwise be printed, impressed, or stamped into the viewable front surface of the substrate.

Referring to FIG. 8, one example of an illuminable textural element 30 is illustrated. The textural element 30 shown in FIG. 6 is formed on the windshield 42 which provides the component or substrate. The interior surface 64 of the windshield 42 has a long persistence phosphor paint 66 provided over a region and a frit in the form of black paint 68 applied over the long persistence phosphor paint 66. The frit formed with black paint 68 may be patterned to include the binary codes 32A-32D or hexadecimal codes providing the coded message. It should be appreciated that sunlight 70 from the sun 72 may impinge upon the outer surface 62 of the windshield 42 and may illuminate the long persistence phosphor paint 66 which in turn illuminates the binary coded message provided on the frit with black paint 68. It should be appreciated that the textural element 30 may be formed along a periphery edge of the windshield 42, such as a top or a bottom portion of the windshield 42 or a side or corner portions of the windshield 42.

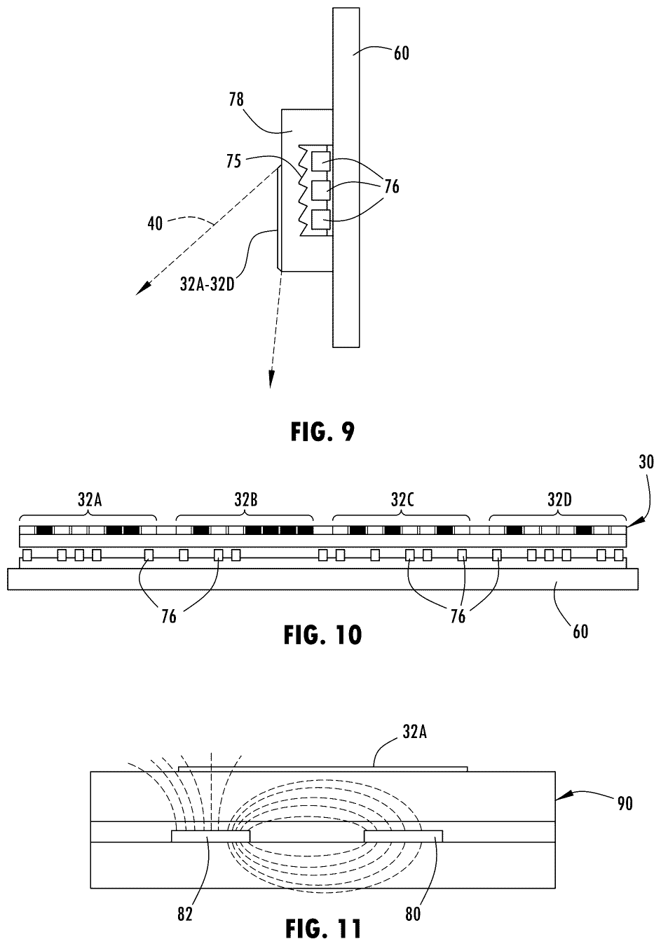

Referring to FIG. 9, a backlit illuminated textural element 30 is illustrated, according to one example. In this example, light sources 76 are positioned between a first component 60 and an optical element 75, such as a lens. In operative communication with the optical element 75 is a second substrate 78 which includes the binary codes 32A-32D in one embodiment or hexadecimal coding in another embodiment providing the coded message on the front viewable surface. As such, the light sources 76, which may include a plurality of light emitting dials for the LED cap(s) may be illuminated to illuminate in a light beam via optics 75 the coded message on the second substrate 78 to generate an illuminated light beam 40 which may illuminate a surface such as the ground proximate to the motor vehicle 10.

Referring to FIG. 10, the textural element 30 is illustrated on a component 60 such as a dashboard with a plurality of light sources 76 positioned behind digital 1s (ones) of the binary bits of the binary codes 32A-32D providing the binary coded message. As such, the illuminated light sources 76 may illuminate clear regions that define the digital 0s (zeros) and light may be prevented from penetrating through the opaque regions that define the digital 1s (ones) so as to provide the coded message.

It should be appreciated that backlighting may be provided to illuminate the coded message, for either the embodiment that includes a binary coded message or the embodiment that includes the hexadecimal message. The backlighting may include red-blue-green LEDs for providing a selected color for each of the binary codes for the binary coding embodiment. For the hexadecimal coding embodiment (RBG), LEDs may provide different colors for each hexadecimal digit referred to as digits 0 (zero) through 9 (nine) and A through F, with each color being different from the other color in representing a given digit. As such, a color pattern may provide the coded message.

It should further be appreciated that the illuminated message may be controlled and changed to a new message with the use of a controller and an input, such as a touchscreen display or an audible input, for example, for receiving the desired message. The backlit light colors may be changed to provide a new illuminated coded message such as a message announcing an anniversary, a birthday, a holiday, a special event, a milestone for the vehicle, etc., for example. It should be appreciated that the coded message may include a personalized message and may allow a user to pick and choose the desired message and to build a custom printed message for use on various components, such as those components located on a vehicle.

A proximity switch in the form of a capacitive switch 90 is shown as a component in FIG. 11 having the binary code 32A provided on the viewable front surface, according to a further example. The binary code 32A may be a coded identifier for the switch 90. The capacitive switch 90 includes first and second electrodes 80 and 82. It should be appreciated that a series of proximity switches may be provided, each having a coded or hexadecimal coded pattern or message on the front viewable surface.

It should be appreciated that the textural element 30 may be located in any of a number of locations on components including articles of manufacture, such as a motor vehicle or components therefor. It should further be appreciated that the textural elements may be located on functional items such as switches, for example proximity switches, door handles, steering wheels, consoles, rocker panels, bumpers, and other vehicle components. The textural element advantageously provides for a unique coded message.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A textural element comprising:
a component having a front surface; and
coding provided on the front surface of the component, the coding including a plurality of code characters, each code character comprising a plurality of digits.

2. The textural element of claim 1, wherein the plurality of code characters translates to a message.

3. The textural element of claim 2, wherein the message includes at least one of a trade name and logo.

4. The textural element of claim 1, wherein the coding comprises binary coding, and wherein the plurality of digits are binary digits provided as a series of binary bits, each representing digital 1 (one) or digital 0 (zero).

5. The textural element of claim 4, wherein the digital 1s (ones) and digital 0s (zeros) are represented by dark and light markings.

6. The textural element of claim 5, wherein the dark and light markings are represented as rectangular boxes or circular shaped.

7. The textural element of claim 4, wherein the digital 1s (ones) and digital 0s (zeros) are represented by opaque and transparent markings.

8. The textural element of claim 1 further comprising a light illumination source operatively coupled to the coding for illuminating light through the transparent markings.

9. The textural element of claim 8, wherein the component is on a door on a vehicle, wherein the illuminated pattern is illuminated to the exterior of the vehicle.

10. The textural element of claim 1, wherein the component is provided on a dashboard or trim panel of a vehicle.

11. The textural element of claim 1, wherein the coding comprises hexadecimal coding.

12. A textural element comprising:
a substrate having a front surface; and
binary coding provided on the front surface of the substrate, the binary coding including a plurality of binary code characters, each binary code character comprising a plurality of binary digits.

13. The textural element of claim 12, wherein the plurality of binary code characters translates to a message.

14. The textural element of claim 12, wherein the plurality of binary digits are provided as a series of binary bits, each representing digital 1 (one) or digital 0 (zero).

15. The textural element of claim 14, wherein the digital 1s (ones) and digital 0s (zeros) are represented by dark and light markings.

16. The textural element of claim 15, wherein the dark and light markings are represented as rectangular boxes or circular shaped.

17. The textural element of claim 14, wherein the digital 1s (ones) and digital 0s (zeros) are represented by opaque and transparent markings.

18. The textural element of claim 17 further comprising a light illumination source operatively coupled to the binary coding for illuminating light through the transparent markings.

19. The textural element of claim 18, wherein the substrate is one of a door of a vehicle, a dashboard or trim panel of the vehicle.

20. A textural element for a vehicle, the textural element comprising:
a component having a front surface; and
binary coding provided on the front surface of the component, the binary coding including a plurality of binary code characters, each binary code character comprising a plurality of binary digits.
